(19) United States
(12) Patent Application Publication
(10) Pub. No.: US 2026/0134784 A1
(43) Pub. Date: May 14, 2026

(54) Lesson Creator Capability Within On-Line Instructional System and Tools

(71) Applicant: Saras-3D, Inc., Allentown, PA (US)

(72) Inventors: Bipin D. Dama, Bridgewater, NJ (US); Kalpendu Shastri, Orefield, PA (US); Soham Pathak, Allentown, PA (US); Terry Ki Lim, Emmaus, PA (US); Ankita Shastri, Marysville, WA (US)

(73) Assignee: Saras-3D, Inc., Allentown, PA (US)

(21) Appl. No.: 18/706,248

(22) PCT Filed: Nov. 15, 2022
(86) PCT No.: PCT/US2022/049901

§ 371 Date: Apr. 30, 2024

Related U.S. Application Data
(60) Provisional application No. 63/279,888, filed on Nov. 16, 2021.

(51) Int. Cl. G09B 5/06; H04L 9/40

(52) U.S. Cl. CPC G09B 5/06; H04L 63/102

(57) ABSTRACT

A lesson creator module is provided at a network-based learning platform to allow for authorized teachers to access a library of existing lesson modules stored at the platform and build a customized lesson (or series of lessons) with their own audio. The lesson creator is configured to capture a teacher's audio presentation of that lesson from the teacher's microphone in a manner that the audio remains in sync with the selected lesson module. Preferably, any other keystrokes, mouse movements, manipulation of 3D objects, etc., as, performed by the teacher are also transmitted to the lesson creator and stored along with the audio track.

### CROSS-REFERENCE TO RELATED APPLICATIONS

This application claims priority from U.S. Provisional Application No. 63/279,888, filed Nov. 16, 2021 and herein incorporated by reference.

### TECHNICAL FIELD

This invention relates to on-line instructional systems and, more particularly, for the ability for an instructor to access available lesson modules and create a customized presentation which may be stored and thereafter accessed by his/her students, as well as to some extent by other educators.

### BACKGROUND OF THE INVENTION

Various prior art educational platforms exist for use in a virtual learning environment. One prior art offering provides a seamless platform that utilizes live lectures (such as via Zoom, YouTube, or the like) in combination with pre-recorded lectures. In addition, it provides features and tools that are useful to a teacher (such as remote questioning of students, giving tests, and the like). Another platform is known to provide live tutoring over Zoom between people anywhere in the world.

The need for excellence in a “distance learning” mode has become quite evident during the recent time of pandemic isolation. One such distance learning methodology is based on self-directed instruction initiated by a student without live teacher involvement and includes the use of three-dimensional (3D) models of various objects (variously referred to as “manipulatives” in academic parlance) that are observable by a student wearing 3D stereoscopic glasses (or similar technology).

One exemplary endeavor to include access to 3D learning models has been developed by the Applicant and embodied in an international patent application PCT/US2019/057289, entitled “On-Line Instructional System and Tools for Student-Centered Learning”, incorporated herein by reference. As described therein, this system uses a platform-based resource that allows for students in disparate locations to access and learn from pre-existing lesson modules that also incorporate the use of 3D objects that may be manipulated by the students.

While a significant advance in the art, there is still a desire to enable individual teachers to modify these pre-existing lesson modules, as needed, to meet the needs of their students. In particular, creating engaging videos with various interactive and teaching tools, like 3D objects, is a complex process that requires specialized hardware and software to simultaneously capture what the teacher is saying along with capturing the computer graphics commands used in the manipulation of 3D objects (or any other associated teaching tool). There is a need to simplify the process and make it easier to create recorded lessons with interactives provided by an educational application.

### SUMMARY OF THE INVENTION

The present invention relates to the technology described in our above-referenced application and enhances its capability by allowing an instructor (i.e., teacher, professor, or other nominated “host” for a learning environment, and for brevity purposes hereafter referred to simply as “teacher”) to access the library of pre-existing lesson modules and build a customized lesson (or series of lessons) with their own audio. A teacher is provided the capability to record an audio sound track that will accompany the existing lesson module. The audio is recorded in a relatively straightforward manner via control commands from the platform (instead of a teacher trying to piece together various audio/video technologies and techniques that may be frustrating, or even unworkable or non-reproducible at times).

In certain embodiments of the present invention, any computer commands (keystrokes, mouse movements/clicks, etc.) used by the teacher to control the flow of the lesson presentation are transmitted to the learning platform along with the audio track, enabling a later play-back by a student to better re-create an actual classroom experience. Advantageously, the computer commands may include those related to the manipulation of 3D objects, allowing for the same 3D manipulation to appear on a student's display during play-back (the student needing to use 3D glasses or the like for proper viewing).

Other embodiments of the present invention provide additional editing capabilities for a teacher to interact with the learning platform and edit pre-existing learning modules to meet their particular instruction goals. For example, a teacher may be given the capability to delete certain modules from a lesson series, or change the order in which certain modules are presented.

Yet further embodiments of the present invention are contemplated as permitting a teacher to upload individual content (slides, 3D objects, etc.) to be incorporated into a particular lesson module.

An exemplary embodiment of the present invention may take the form of a network-based learning platform configured to provide customized instruction, wherein the learning platform includes a knowledge base based upon a plurality of separate databases (each database associated with a different academic discipline and including a plurality of individual lesson modules) and a lesson creator module, accessible only to authorized individuals. The lesson creator module is in communication with the knowledge base and presents selected individual lesson modules to an authorized teacher, permitting the authorized teacher to edit the presented, selected individual lesson module to create a customized presentation. The customized presentation is thereafter stored at the network-based learning platform in association with a unique ID paired with the authorized teacher for later access by authorized students. The learning platform may also include a service management component that is utilized as a communication interface between individuals and the lesson creator, the service management component configured to include a validation element to allow only authorized teachers to prepare customized lesson sessions by accessing and utilizing the lesson creator module.

The use of a network-based learning platform accessible by subscribed teachers and students may further enhance the capabilities of distance learning in other aspects, such as including the capability of translating a teacher's audio into various other languages supported by the platform, including the capability to present a “closed caption” version of the audio.

Other and further aspects and embodiments of the present invention may become apparent during the course of the following discussion and by reference to the accompanying drawings.

### BRIEF DESCRIPTION OF THE DRAWINGS

Referring now the drawings,

FIG. 1 illustrates an exemplary network architecture useful in providing teacher editing control of pre-existing lesson modules resident within a remotely-located learning platform;

FIG. 2 illustrates an exemplary presentation of a selected lesson module on a teacher's computing device, enabling the teacher to interact with the module and create their own lesson script;

FIG. 3 illustrates an instance of the play-back of a teacher's created lesson on a student's computing device;

FIG. 4 is a diagram illustrating an advanced editing feature of the inventive lesson creator that allows for an authorized teacher to re-order the material contained within a lesson module;

FIG. 5 is a diagram of yet another editing feature, in this case to allow for an authorized teacher to prepare a set of different lesson scripts for the same lesson module, the different scripts prepared for different student audiences;

FIG. 6 is a diagram of another editing capability, in this case the ability to delete a portion of the lesson material; and

FIG. 7 is a diagram of showing an advanced editing capability as allowing for an authorized teacher to upload and embed independently-created material into the customized presentation.

### DETAILED DESCRIPTION

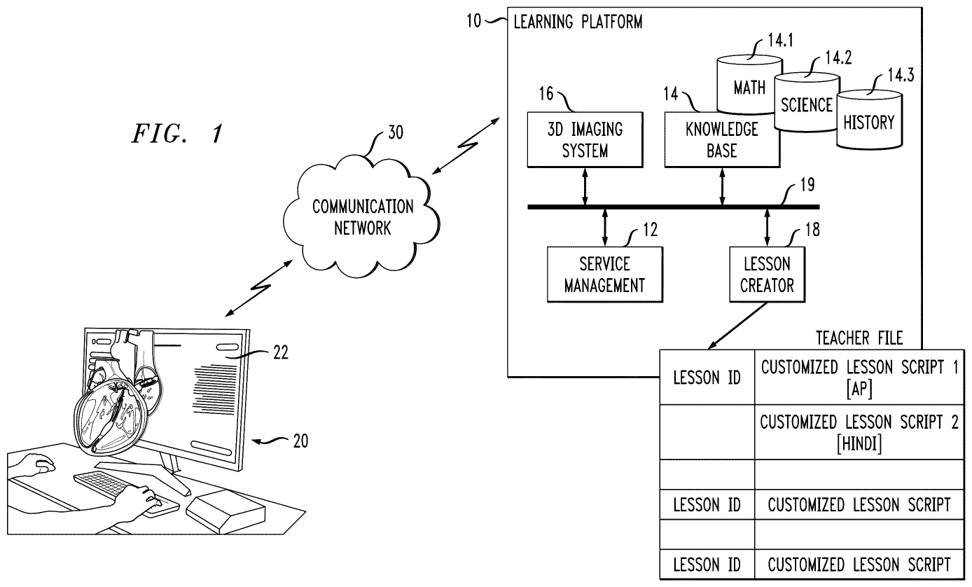

FIG. 1 is a diagram of an exemplary architecture where a network-based learning platform 10 is configured to allow teachers to interact with stored lesson material and create a presentation that is tailored to meet their individual needs.

In this exemplary embodiment, learning platform 10 is shown as including a service management component 12, a knowledge base 14, a 3D imaging system 16, and a teacher customization module 18 (hereinafter referred to as “lesson creator module 18”). In this particular architecture, the individual elements forming the learning platform are capable of sharing data and other communication with each other via a communication bus 19.

Also shown in FIG. 1 is a computer system 20 that is able to communicate with learning platform 10 over a communication network 30 (where communication network may comprise the internet, or any suitable public or private communication network). It is this configuration that permits a teacher having access to computer system 20 to interact with pre-existing lesson modules stored within knowledge base 14 of learning platform 10 and modify them as desired to create their own presentations. The teacher-created versions of the lessons are recorded and stored within lesson creator module 18 in a manner that allows for identified students to thereafter access that teacher's created lesson. It is an aspect of the present invention that computer system 20 has installed a required educational software application that includes the capabilities to view and manipulate 3D objects as included in specific lesson modules.

Service management component 12 of learning platform 10 functions as the communication interface between network 30 and the other elements within learning platform 10. While service management component 12 may be used to control access to learning platform 10 in the first instance, it may be used in accordance with the principles of the present invention to validate subscriptions to the “lesson creator” option. The validation may include not only granting access to lesson creator module 18, but also managing various access levels and functionalities that may be available to different subscribed users. Additionally, service management component 12 may be used to control the various roles and permissions of a teacher and the students

Knowledge base 14 of learning platform 10 includes sets of lesson modules developed for a number of well-defined academic disciplines. For explanatory purposes only (and thus not considered to limit the scope of the applicability of the present invention), knowledge base 14 is shown in FIG. 1 as including sets of lesson modules for the disciplines of mathematics, science, and history. Shown as database systems 14.1, 14.2, and 14.3, respectively, each general discipline area may be further divided into different subject matter areas, with topics defined for each subject matter area, and lesson modules (typically including a multiple number of individual sessions) associated with each subject matter area. It is to be understood that the specific architecture of knowledge base 14 is not particularly relevant to the subject matter of the present invention, as long as individuals are able to follow the hierarchy and access the specific modules required for their lesson planning purposes.

3D imaging system 16, also included in learning platform 10, provides the ability to add the third dimension to the presented material and giving the student a more “real world” setting within which to learn the material being presented. As described in our co-pending application, the provision of 3D tools is considered to enhance the learning experience by “breaking through” the barrier of a computer display screen, allowing a student to engage with the presented subject matter in a real-world fashion.

The above-referenced components are described in detail in Applicant's above-referenced application. In particular with the principles of the present invention, their capabilities are enhanced by allowing subscribed teachers to edit the material stored in knowledge base 14 to meet their individual instructional goals. As will be discussed in detail below, lesson creator module 18 is also included within learning platform 10 and permits certain modifications of lesson material stored in knowledge base 14, recording these modifications in an individual teacher file within lesson creator module 18 so that students may thereafter access a specific teacher's presentation of lesson modules.

As briefly mentioned above, service management component 12 may be used to not only validate the existence of a “lesson creator” subscription for a particular teacher, but thereafter recognize a level of subscription associated with that individual. That is, one teacher may have only a “basic” subscription that allows for the recording of audio to accompany existing lesson modules. Another teacher may have a higher level of subscription that includes the capabilities for his/her computer commands to also be transmitted to learning platform 10 and stored with the recorded audio. As will be described in detail below, higher levels of subscription may also be provided and give a teacher the ability to re-order existing lesson modules and/or upload personal content to be included in their recorded lesson.

A similar type of authentication and permission process may be used by service management component 12 to control student access to lesson creator 18. In particular, students would have a type of “read only” access, enabling them to retrieve lessons created by their teacher(s), with no means to edit the presented material. Certain schools, learning centers, communities, or the like may have different levels of subscription, depending on the needs in their specific learning environments. While not shown in detail, it is contemplated that services management component 12 includes individual elements that perform user verification, record and store access history logs, monitor subscription records, and the like.

With the understanding of the functionality of these elements, various details embodied within the inventive lesson creator module will be described below. At a most basic level, once a teacher has selected a specific lesson module to customizer, and has activated that lesson on their device (such as computer device 20 of FIG. 1), lesson creator module 18 is configured to be able to capture a teacher's audio presentation of that lesson using the microphone on computer device 20, remaining in sync with the advancement of slides forming the lesson. Well-known techniques, such as using timestamps on the slide show and audio, enable this capability. Preferably, any other keystrokes, mouse movements, etc., performed by the teacher as the lesson is presented, are also transmitted to lesson creator 18 and stored along with the audio track. The teacher's use of various visual interactives (e. g., 3D models, 3D simulations, images, textual models, quizzes, etc.) that are available within knowledge base 14 can also be recorded and translated into executable code in the lesson script such that it can be precisely reproduced by running the lesson script. For the purposes of the present invention, the term “script” refers to the complete list of commands/information generated by a teacher during the creation of a lesson session. The lesson script is recorded and stored at the learning platform. Thereafter, subscribed students are able to access the stored lesson script (in combination with the actual lesson module itself) and replay the lesson on their own computer.

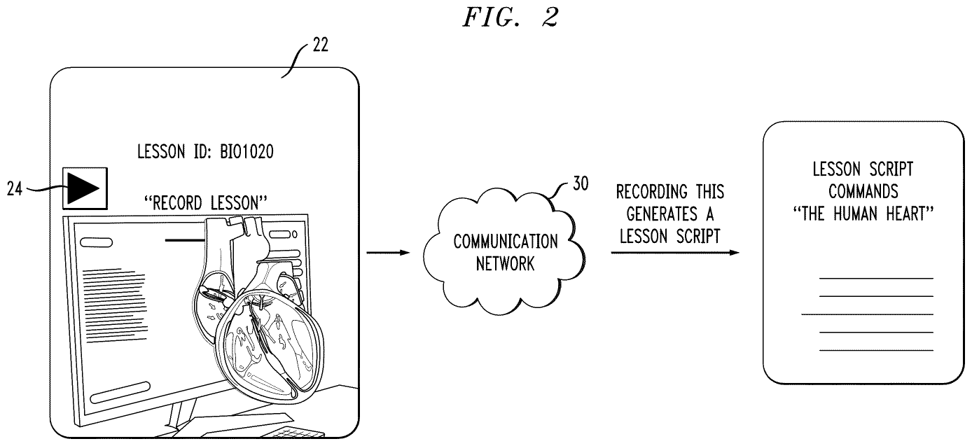

As shown in FIG. 2, as exemplary embodiment of the present invention may present command lines on the teacher's display 22, including clickable icon(s) 24. For example, the information shown on display 22 includes the unique lesson ID assigned to the specific lesson module by knowledge base 14. Also shown on display 22 is a typical “record” icon 24, with an associated instruction, such as “activate a record lesson mode.” In one embodiment, clicking on the “record” icon prompts the teacher to speak into the microphone on computer device 20. If this records an audio signal with a recurring amplitude above a defined threshold, the teacher is prompted to continue; otherwise, the teacher may be prompted to attach a headset with a microphone to improve the quality of the audio recording. The provision of this type of capability via lesson creator module 18 makes it possible to eliminate the need for teachers to have access to specialized recording hardware and software. As the teacher advances through the lesson material, a lesson script 18-1 is created, where the audio is timestamped to remain synchronized with the advancement of slides through the lesson material, as described above.

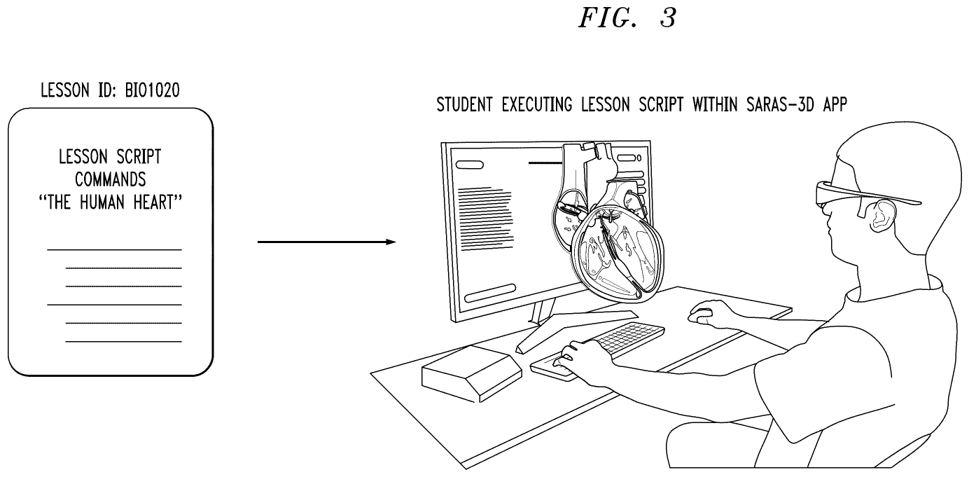

Summarizing, once a subscribed teacher has logged onto enhanced lesson platform 10 and been validated by service management component 12 as having permission to access lesson creator module 18, they can record an audio commentary on the presented material (with timestamps included to ensure that the audio remains synched with the presentation of material in the educational application). At some point in time thereafter, a student who has proper permissions is able to access the teacher's customized lesson (perhaps using unique IDs associated with each teacher, lesson module, and recording) and view the customized lesson as prepared by his/her teacher. FIG. 3 illustrates this step of “play-back” at a student location.

Once recorded, each teacher-created lesson modification is stored within lesson creator 18 as an executable script, where it is contemplated that the teacher/creator has the ability to control who may access that file. In contrast to trying to capture the teacher's screen during the lesson (which might generate something like an .mp4 file) and re-play it as a video, executing a “lesson script” that is saved instead as a C #file, for example, in accordance with the principles of the present invention greatly reduces the bandwidth and storage requirements for lessons. The lesson scripts along with the recorded audio can be shared with students (based on license of usage) using the cloud back-end of the inventive learning platform. It is also possible to facilitate standard video platforms by rendering videos from lesson scripts in the cloud back-end.

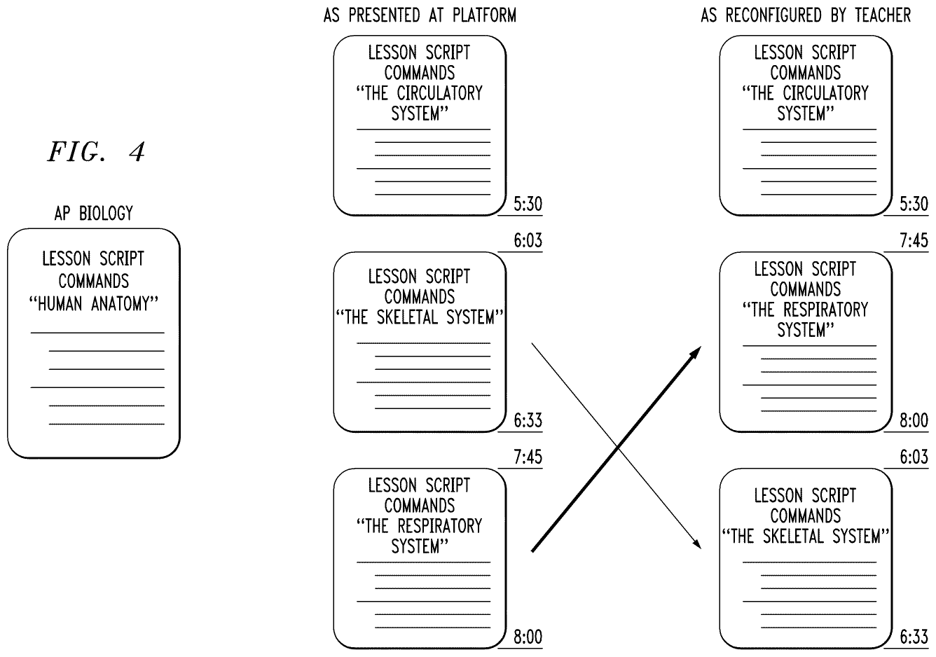

In accordance with the teachings of the present invention, the permission levels associated with lesson creator module 18 may permit a properly subscribed and authorized teacher to re-order a sequence of lesson modules after concluding an initial recording. This is shown in the diagram of FIG. 4, which shows knowledge base 14 as including “AP Biology” as one of its subject matter areas, which includes a set of three different lessons modules. A teacher with access to this set of lesson modules may performing an initial recording using all three. Thereafter, upon review/editing, the teacher decides that the respiratory system lesson module needs to be presented (for their purposes) before the skeletal system lesson module. An advanced editing tool within lesson creator 18 is presented with a simple interface, such as drag-and-drop of selected portions, and allows for these modules to be “swapped”, as shown in FIG. 4. In the backend, this generates another lesson script where this change is recorded. In accordance with the teachings of the present invention, since a continuous timestamp is used (as shown) to maintain synchronization with the presented material, the recorded script is able to follow the new sequence, since the audio is timestamped and paired to coordinate with the original lesson presentation.

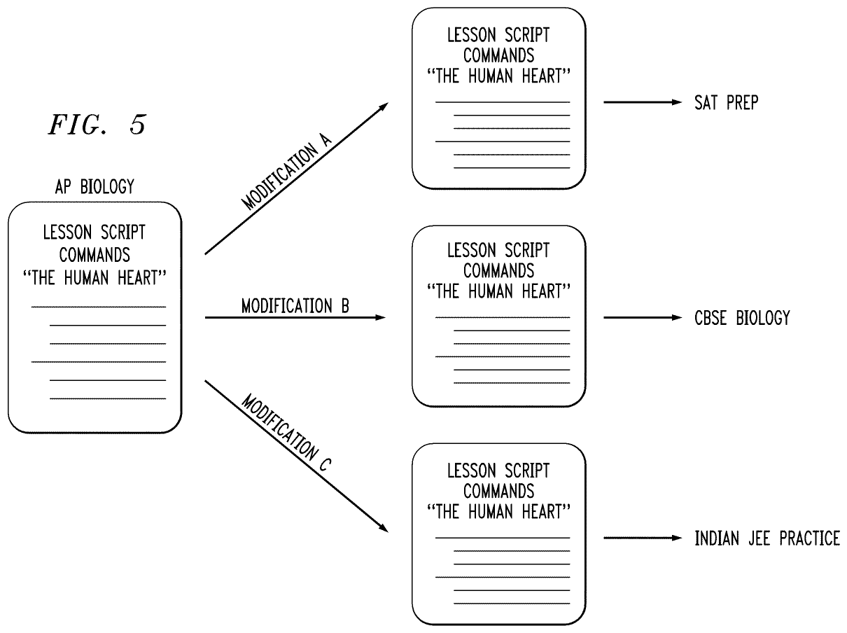

FIG. 5 presents another feature of lesson creator module 18, in particular the ability to record different “scripts” for the same content, as a function of the purpose for the presented material. For example, if the original “lesson script” was made for an AP Biology class (where the lesson can be tagged as such), modification A might include an explanation of an example SAT question; modification B might include a translation from English to Hindi; modification C might include practice questions for the JEE exam. Additionally, once a lesson script has been made, it can be modified to execute it in a different language (perhaps by the teacher activating a “select language” icon on their display), or adding closed-captioning to the presentation. In all of these cases, the unique ID for each variation may include a “tag” describing the particular details of that variation (e. g., “English lang”, “Hindi lang”, “JEE”, “AP”). Obviously, the number and types of variations that a teacher may use to supplement/modify their customized presentation is almost limitless.

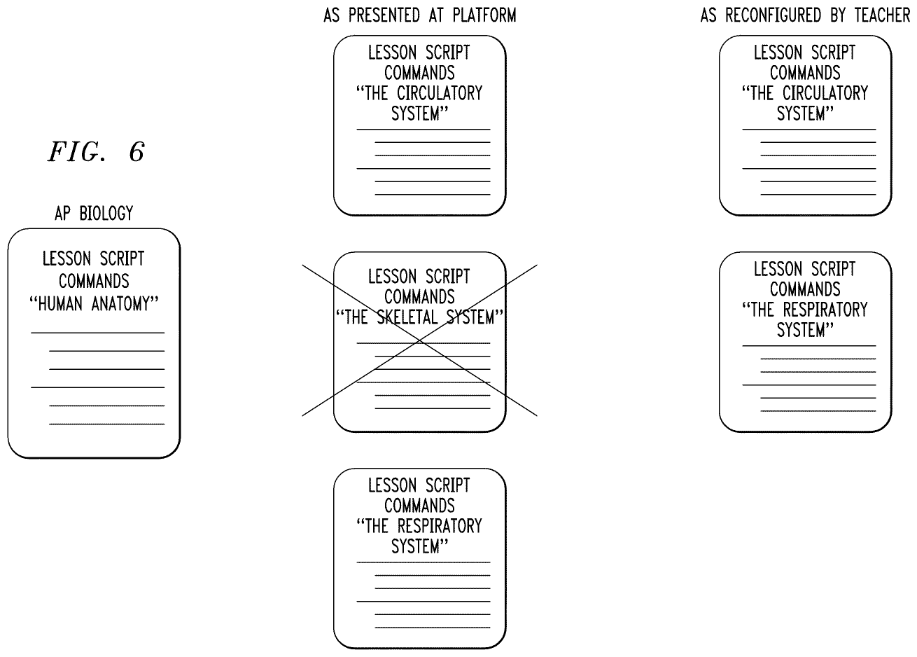

FIG. 6 illustrates yet another capability of a subscribed teacher to use lesson creator for editing purposes. In this example, a teacher is given the permission to modify a pre-existing lesson by eliminating selected module(s) within a lesson; it is to be understood that this edited lesson structure is uniquely identified with that specific teacher and only found within the material that teacher has stored within lesson creator module 18. The original material as found in knowledge base 14 remains intact.

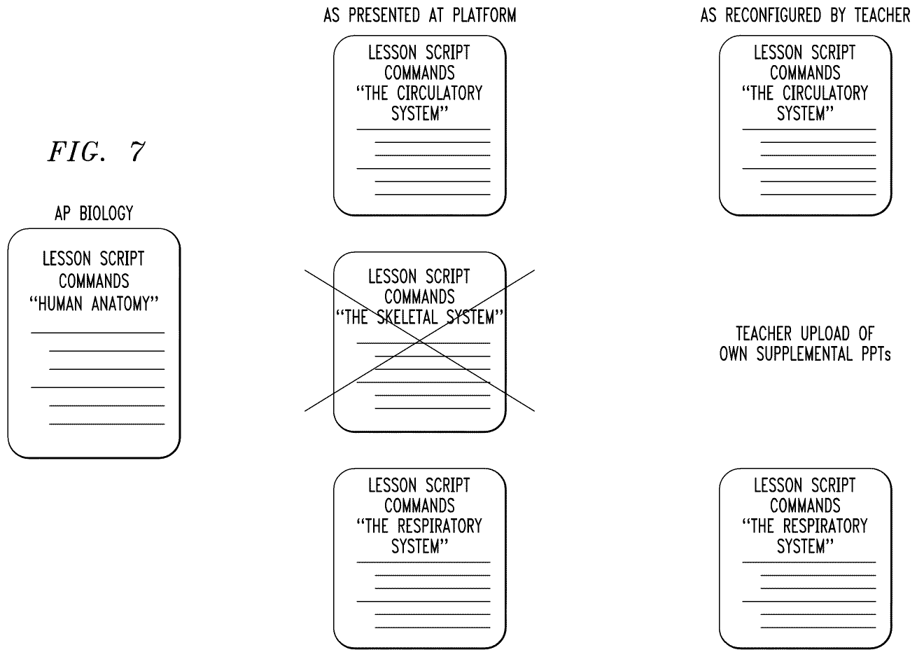

In another embodiment of the present invention, a teacher may have a feature-rich subscription level, allowing the teacher to supplement the lesson being created by using their own content that may be uploaded (e.g., PDFs, PPTs, etc.) , as illustrated in FIG. 7. This content would only be available for that teacher to use, unless other permissions are given.

With respect to the aspect of permissions, another feature of the present invention is related to giving permission to a subscribed teacher to “offer” a created lesson script for use by other third parties. The lesson script would be vetted for compliance with various requirements (copyright, content, etc.) and available at the platform for use by other teachers with access to the platform. In this way, approved content may be shared with others that are “outside” of the initial class for whom the material was created, whereupon the teachers who created the content would be appropriately compensated.

Summarizing, the present invention is directed to the generation and execution of a “lesson script” that automatically re-plays a customized lesson created by a teacher in a manner that is more efficient (in terms of bandwidth and storage) than a standard video playback. The ability to provide modifications to an existing “lesson script” (for example, to use in multiple learning settings), is another aspect of the present invention that allows for global scaling of educational content, with the added ability to gear it towards certain educational settings.

One skilled in the relevant art will recognize that many possible modifications and combinations of the disclosed embodiments may be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

What is claimed is:

1. A network-based learning platform configured to provide customized instruction, comprising:
a knowledge base including a plurality of separate databases, each database associated with a different academic discipline and including a plurality of individual lesson modules;
a lesson creator module, accessible only to authorized individuals, the lesson creator module in communication with the knowledge base for presenting selected individual lesson modules to an authorized teacher and permitting the authorized teacher to edit the presented, selected individual lesson module to create a customized presentation, the customized presentation thereafter stored at the network-based learning platform in association with a unique ID paired with the authorized teacher; and
a service management component utilized as a communication interface between individuals and the lesson creator, the service management component configured to include a validation element to allow only authorized teachers to prepare customized lesson sessions by accessing and utilizing the lesson creator module.

2. The network-based learning platform as defined in claim 1 wherein the validation element permits only authorized students to access a customized lesson session prepared by an identified teacher.

3. The network-based learning platform as defined in claim 1 wherein the lesson creator module is configured to permit an authorized teacher to record an audio file in synchronization with a selected individual lesson module.

4. The network-based learning platform as defined in claim 3 wherein the lesson creator module is further configured to permit an authorized teacher to record multiple, different audio files in association with the selected individual lesson module, each different audio file prepared for a different purpose.

5. The network-based learning platform as defined in claim 4 wherein the different audio files are prepared for different student audiences.

6. The network-based learning platform as defined in claim 4 wherein each different audio file is tagged with descriptive information identifying its purpose.

7. The network-based learning platform as defined in claim 3 wherein the lesson creator module is further configured to translate the audio file into a different language.

8. The network-based learning platform as defined in claim 1 wherein the platform further comprises a 3D imaging system component, in communication with the knowledge base and the lesson creator module.

9. The network-based learning platform as defined in claim 8 wherein an authorized teacher is permitted to incorporate movements of selected 3D objects with a lesson script to be recorded and stored in the lesson creator module, the lesson script including commands executable thereafter by a validated student to view the authorized teacher's movements of the selected 3D objects.

10. The network-based learning platform as defined in claim 1 wherein the lesson creator module is further configured to present an editing interface to an authorized teacher during the creation of the customized presentation.

11. The network-based learning platform as defined in claim 10 wherein the editing interface permits the authorized teacher to modify a sequence of a recorded lesson script, including deleting selected portions of the recording lesson script.

12. The network-based learning platform as defined in claim 10 wherein the editing interface is configured to permit an authorized teacher to upload and incorporate independently-created lesson material within the individual lesson module selected for customization.

13. The network-based learning platform as defined in claim 12 wherein the service management component is further configured to permit the authorized teacher to allow other selected, authorized teachers to access the customized presentation incorporating the independently-created lesson material.

14. The network-based learning platform as defined in claim 12 wherein the service management component is further configured to maintain a record of access events to provide for a remuneration of the authorized teacher on the basis of the number of access events.
